(19) United States
(12) Patent Application Publication
(10) Pub. No.: US 2018/0056966 A1
(43) Pub. Date: Mar. 1, 2018

(54) BRAKE HYDRAULIC PRESSURE CONTROLLER AND MOTORCYCLE

(71) Applicant: Robert Bosch GmbH, Stuttgart (DE)

(72) Inventors: Hiroaki Atsushi, Kanagawa (JP); Kosaku Sagayama, Kanagawa (JP); Makoto Sasaki, Kanagawa (JP)

(21) Appl. No.: 15/678,298

(22) Filed: Aug. 16, 2017

(30) Foreign Application Priority Data
Aug. 25, 2016 (JP) 2016-165085

(51) Int. Cl. B60T 17/04; B60T 8/32; B60T 8/36

(52) U.S. Cl. CPC B60T 17/043; B60T 8/3645; B60T 8/368; B60T 8/3225

(57) ABSTRACT

A brake hydraulic pressure controller includes a base body that is formed with a channel for a hydraulic fluid therein. A first banjo with a first end, to which a brake pipe is connected, is fixed to a first port of the channel by a banjo bolt. A second end of the first banjo, to which the brake pipe is not connected, is inserted in a bottomed hole that is perforated in specified depth on an outer surface of the base body and into which the hydraulic fluid does not flow in an entire region of the specified depth, or extends to the outside of a side of the base body and is locked to an edge on the side of the base body.

### BACKGROUND OF THE INVENTION

The invention relates to a brake hydraulic pressure controller and a motorcycle.

Conventionally, in regard to a braking device of a vehicle such as a motorcycle (a two-wheeled motorized vehicle or a three-wheeled motorized vehicle), when an occupant of the vehicle operates a brake lever, pressure of a hydraulic fluid in a brake fluid circuit that is filled with the hydraulic fluid is boosted, and a braking force can be generated on a wheel. In addition, it has been known to adopt an antilock brake system (ABS) unit, for example, as a brake hydraulic pressure controller that adjusts the braking force.

This brake hydraulic pressure controller can boost/reduce the pressure of the hydraulic fluid in the brake fluid circuit and can thereby adjust the braking force that is generated on the wheel.

As the brake hydraulic pressure controller, a unit that has: a pump device that changes the pressure of the hydraulic fluid in the brake fluid circuit; a hydraulic pressure regulating valve that boosts/reduces the pressure of the hydraulic fluid; a controller that controls the pump device and the hydraulic pressure regulating valve; and the like has been available (for example, see JP-A-2011-51359).

The pump device and the hydraulic pressure regulating valve are attached to a base body that is formed with a channel, through which the hydraulic fluid flows, therein. A port of the channel is formed on at least one surface of the base body. There is a case where this port is provided with a banjo-type connection structure that is a connection structure used to connect a brake pipe. In the banjo-type connection structure, a banjo bolt is inserted through a banjo that has a cylindrical body, and the banjo bolt is screwed to the port. In this way, the banjo is fixed to a specified surface of the base body, which communicates between the channel and the brake pipe.

The brake hydraulic pressure controller, for which the banjo-type connection structure is used, is preferably provided with a detent mechanism that prevents corotation of the banjo at a time when the banjo bolt is screwed. For example, when such a configuration that a bottomed hole in specified depth is perforated on an outer surface of the base body to form the channel in the base body and that the hydraulic fluid only flows into a deep side of an intermediate section of the bottomed hole by closing the intermediate section is adopted, it is considered to lock the rotation of the banjo by using a region of the bottomed hole into which the hydraulic fluid does not flow. However, in such a case, the bottomed hole is positioned in accordance with a structure of the channel. Consequently, the banjo in such a shape that manufacturing thereof is difficult is possibly required, or arrangement of the brake pipe possibly becomes difficult. In addition, due to stress on the bottomed hole that is generated during screwing of the banjo bolt, it possibly becomes difficult to secure a hydraulic fluid sealing property.

### SUMMARY OF THE INVENTION

The invention has been made with problems described above as the background and therefore has a purpose of improving applicability of a detent mechanism to a brake hydraulic pressure controller and a motorcycle, the detent mechanism being used to prevent corotation of a banjo.

A brake hydraulic pressure controller according to the invention includes a base body that is formed with a channel for a hydraulic fluid therein. A first banjo with a first end, to which a brake pipe is connected, is fixed to a first port of the channel by a banjo bolt. A second end of the first banjo, to which the brake pipe is not connected, is inserted in a bottomed hole that is perforated in specified depth on an outer surface of the base body and into which the hydraulic fluid does not flow in an entire region of the specified depth, or extends to the outside of a side of the base body and is locked to an edge on the side of the base body.

A motorcycle according to the invention includes the above-described brake hydraulic pressure controller.

In the brake hydraulic pressure controller according to the invention, the second end of the first banjo, to which the brake pipe is not connected, is inserted in the bottomed hole that is perforated in the specified depth on the outer surface of the base body and into which the hydraulic fluid does not flow in the entire region of the specified depth, or locked to the edge on the side of the base body. Accordingly, a structure of the channel, a hydraulic fluid sealing property, and the like become less restrictive. Thus, applicability of the detent mechanism that prevents corotation of the banjo is improved.

The motorcycle according to the invention can handle a stringent request for downsizing of built-in equipment by adopting the above-described brake hydraulic pressure controller.

### BRIEF DESCRIPTION OF THE DRAWINGS

FIG. 1 is a view schematically illustrating one example of a configuration of a motorcycle that includes a brake system having a brake hydraulic pressure controller according to a first embodiment;

FIG. 2 is a configuration diagram illustrating one example of a configuration of the brake system having the brake hydraulic pressure controller according to the first embodiment;

FIG. 3 is a perspective view of the brake hydraulic pressure controller according to the first embodiment;

FIG. 4 is a perspective view of the brake hydraulic pressure controller according to the first embodiment that is seen at a different angle from FIG. 3;

FIG. 5 is a front view of the brake hydraulic pressure controller according to the first embodiment;

FIG. 6 is a side view of the brake hydraulic pressure controller according to the first embodiment;

FIG. 7 is a top view of the brake hydraulic pressure controller according to the first embodiment;

FIG. 8 is an exploded perspective view of the brake hydraulic pressure controller according to the first embodiment;

FIG. 9 is an exploded perspective view of the brake hydraulic pressure controller according to the first embodiment that is seen at a different angle from FIG. 8;

FIG. 10 is a view illustrating a position of a bottomed hole that is formed in a base body of the brake hydraulic pressure controller according to the first embodiment;

FIG. 11 is a view illustrating the position of the bottomed hole that is formed in the base body of the brake hydraulic pressure controller according to the first embodiment;

FIG. 12 is a view illustrating the position of the bottomed hole that is formed in the base body of the brake hydraulic pressure controller according to the first embodiment;

FIG. 13 is a perspective view of a brake hydraulic pressure controller according to a second embodiment;

FIG. 14 is a perspective view of the brake hydraulic pressure controller according to the second embodiment that is seen at a different angle from FIG. 13;

FIG. 15 is a perspective view of the brake hydraulic pressure controller according to the second embodiment that is seen at a different angle from FIG. 13;

FIG. 16 is a front view of the brake hydraulic pressure controller according to the second embodiment;

FIG. 17 is a side view of the brake hydraulic pressure controller according to the second embodiment;

FIG. 18 is a side view of the brake hydraulic pressure controller according to the second embodiment that is seen from a different side from FIG. 17;

FIG. 19 is a top view of the brake hydraulic pressure controller according to the second embodiment;

FIG. 20 is an exploded perspective view of the brake hydraulic pressure controller according to the second embodiment;

FIG. 21 is an exploded perspective view of the brake hydraulic pressure controller according to the second embodiment that is seen at a different angle from FIG. 20; and

FIG. 22 is an exploded perspective view of the brake hydraulic pressure controller according to the second embodiment that is seen at a different angle from FIG. 20.

### DETAILED DESCRIPTION

A description will hereinafter be made on embodiments of the invention by appropriately referring to the drawings.

Note that the following description will be made on a case where a brake hydraulic pressure controller according to the invention is used for a motorcycle; however, the brake hydraulic pressure controller according to the invention may be used for a vehicle (for example, an automobile, a track, or the like) other than the motorcycle.

Each of a configuration, an operation, and the like, which will be described below, is merely one example, and the brake hydraulic pressure controller according to the invention is not limited to a case with such a configuration, such an operation, and the like. For example, the brake hydraulic pressure controller according to the invention may perform an operation other than that as an ABS.

In each of the drawings, members or portions in the same or corresponding relationship are denoted by the same reference signs or are not denoted. In each of the drawings, detailed portions are illustrated in an appropriately simplified manner or not illustrated.

### First Embodiment

### <Exterior Configuration of Motorcycle 200>

A description will first be made on a configuration of a motorcycle 200.

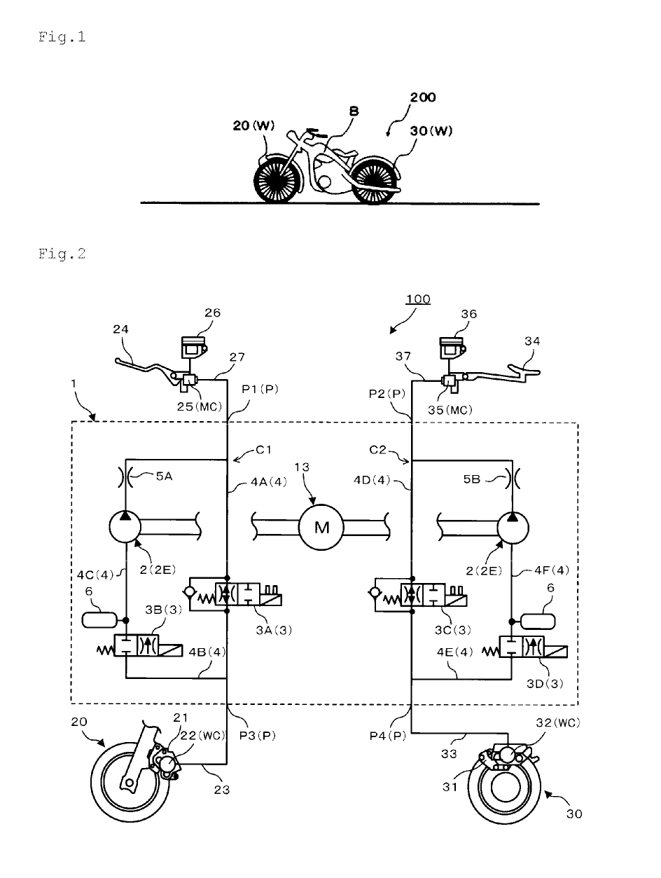

FIG. 1 is a view schematically illustrating one example of a configuration of a motorcycle that includes a brake system having a brake hydraulic pressure controller according to a first embodiment.

The motorcycle 200 is configured by combining wheels W, a vehicle body B, and a brake system 100. The vehicle body B includes all components of the motorcycle 200 other than the brake system 100 and the wheels W. Note that the motorcycle 200 will be described as a two-wheeled motorized vehicle in the first embodiment; however, the motorcycle 200 is not limited thereto and may be a three-wheeled motorized vehicle.

### <Overall Configuration of Brake System 100>

Next, a description will be made on an overall configuration of the brake system 100.

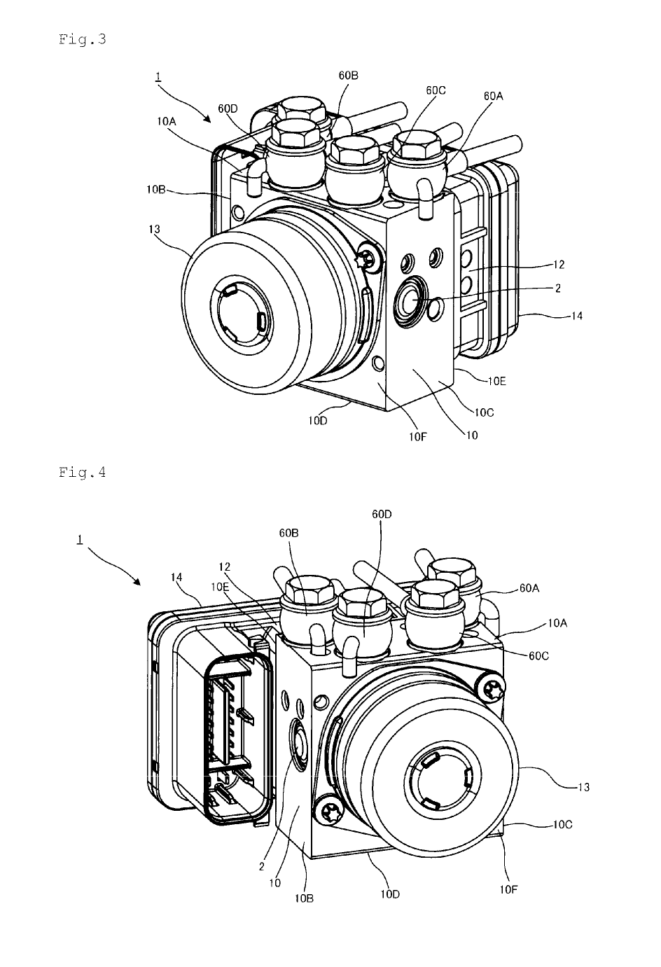

FIG. 2 is a configuration diagram illustrating one example of the configuration of the brake system having the brake hydraulic pressure controller according to the first embodiment.

The brake system 100 includes a brake hydraulic pressure controller 1 that changes a braking force generated on the wheels W of the motorcycle 200.

The brake system 100 also includes a handlebar lever 24 and a foot pedal 34 that are operated by a user who drives the two-wheeled motorized vehicle, or the like. When this handlebar lever 24 is operated, the braking force is generated on a front wheel 20. When the foot pedal 34 is operated, the braking force is generated on a rear wheel 30.

The brake system 100 includes: a front-wheel hydraulic circuit C1 through which a hydraulic fluid used to generate the braking force on the front wheel 20 flows; and a rear-wheel hydraulic circuit C2 through which the hydraulic fluid used to generate the braking force on the rear wheel 30 flows. The front-wheel hydraulic circuit C1 and the rear-wheel hydraulic circuit C2 each include an internal channel 4 in the brake hydraulic pressure controller 1, which will be described below. In addition, any of various types of brake oil can be used as the hydraulic fluid.

The brake system 100 includes the following configuration as a mechanism that generates the braking force on the front wheel 20, and the like. More specifically, the brake system 100 includes: a front brake pad 21 that is provided in a manner to correspond to the front wheel 20; a front wheel cylinder 22 in which a front brake piston (not illustrated) for actuating the front brake pad 21 is provided in a freely slidable manner; and a brake fluid pipe 23 that is connected to the front wheel cylinder 22.

Note that the front brake pad 21 is provided to sandwich a rotor (not illustrated) that rotates with the front wheel 20. When being pressed by the front brake piston in the front wheel cylinder 22, the front brake pad 21 abuts against the rotor and generates a friction force. In this way, the braking force is generated on the front wheel 20 that rotates with the rotor.

The brake system 100 includes: a first master cylinder 25 that is attached to the handlebar lever 24; a first reservoir 26 that stores the hydraulic fluid; and a brake fluid pipe 27 that is connected to the first master cylinder 25. Note that a master cylinder piston (not illustrated) is provided in a freely slidable manner in the first master cylinder 25. When the handlebar lever 24 is operated, the master cylinder piston in the first master cylinder 25 moves. Because pressure of the hydraulic fluid that is applied to the front brake piston is changed by a position of the master cylinder piston, a force of sandwiching the rotor by the front brake pad 21 is changed, and the braking force on the front wheel 20 is changed.

The brake system 100 includes the following configuration as a mechanism that generates the braking force on the rear wheel 30, and the like. More specifically, the brake system 100 includes: a rear brake pad 31 that is provided in a manner to correspond to the rear wheel 30; a rear wheel cylinder 32 in which a rear brake piston (not illustrated) for moving the rear brake pad 31 is provided in a freely slidable manner; and a brake fluid pipe 33 that is connected to the rear wheel cylinder 32.

Note that the rear brake pad 31 is provided to sandwich a rotor (not illustrated) that rotates with the rear wheel 30. When being pressed by the rear brake piston in the rear wheel cylinder 32, the rear brake pad 31 abuts against the rotor and generates the friction force. In this way, the braking force is generated on the rear wheel 30 that rotates with the rotor.

The brake system 100 includes: a second master cylinder 35 that is attached to the foot pedal 34; a second reservoir 36 that stores the hydraulic fluid; and a brake fluid pipe 37 that is connected to the second master cylinder 35. Note that a master cylinder piston (not illustrated) is provided in a freely slidable manner in the second master cylinder 35. When the foot pedal 34 is operated, the master cylinder piston in the second master cylinder 35 moves. Because pressure of the hydraulic fluid that is applied to the rear brake piston is changed by a position of the master cylinder piston, a force of sandwiching the rotor by the rear brake pad 31 is changed, and the braking force on the rear wheel 30 is changed.

### <Configuration of Brake Hydraulic Pressure Controller 1>

A description will be made on a configuration of the brake hydraulic pressure controller 1 by using FIGS. 2 to 7.

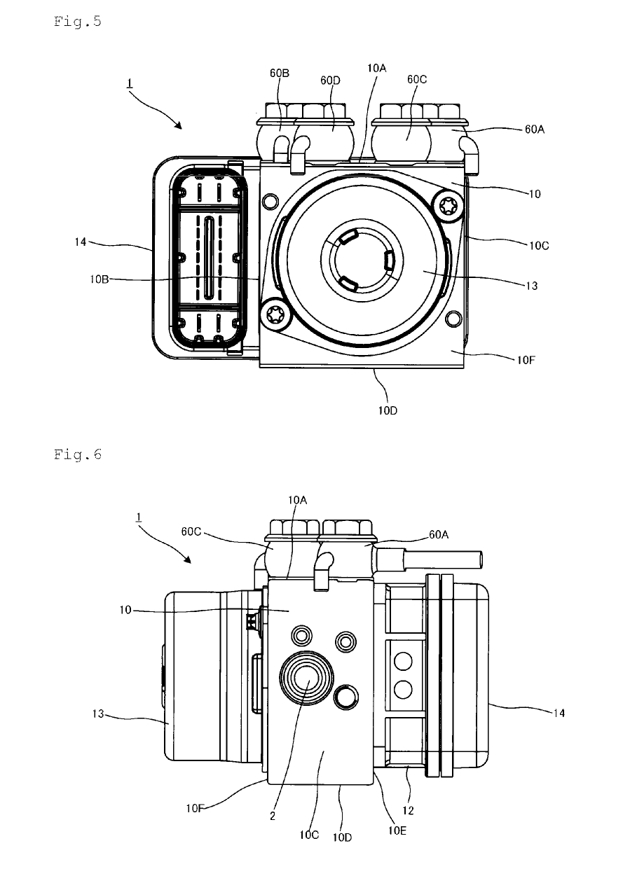

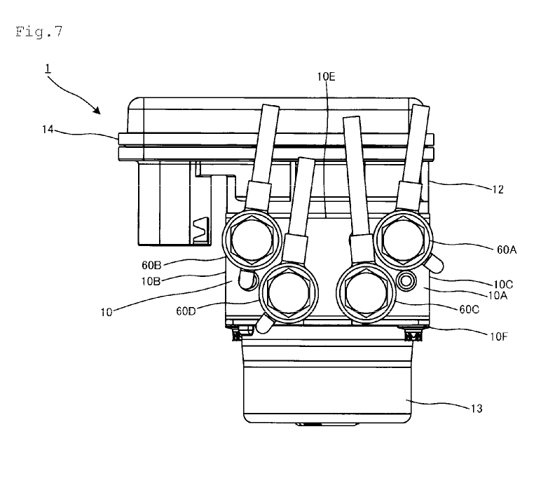

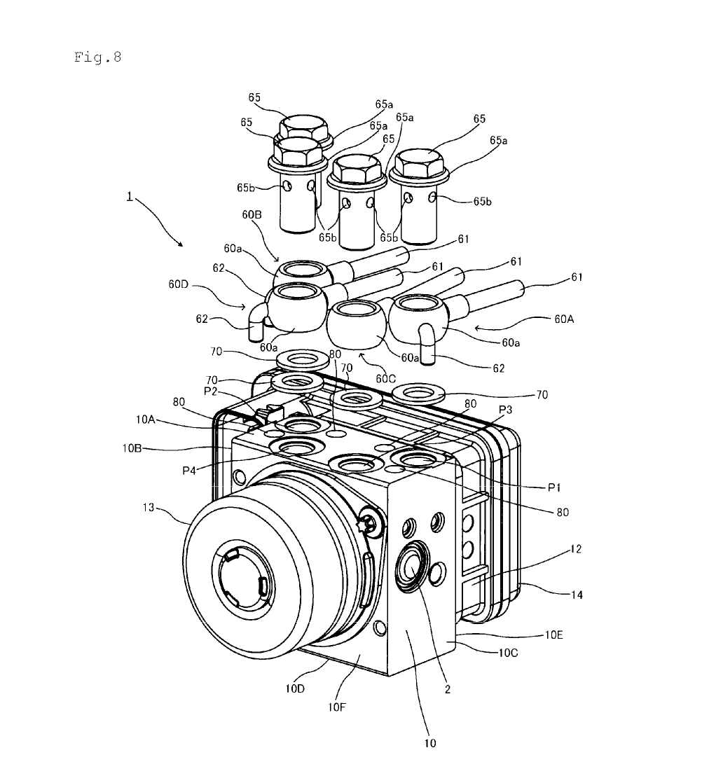

FIG. 3 is a perspective view of the brake hydraulic pressure controller according to the first embodiment. FIG. 4 is a perspective view of the brake hydraulic pressure controller according to the first embodiment that is seen at a different angle from FIG. 3. FIG. 5 is a front view of the brake hydraulic pressure controller according to the first embodiment. FIG. 6 is a side view of the brake hydraulic pressure controller according to the first embodiment. FIG. 7 is a top view of the brake hydraulic pressure controller according to the first embodiment.

The brake hydraulic pressure controller 1 is configured by including: a base body 10 that is formed with the internal channel 4 (see FIG. 2), through which the hydraulic fluid flows; a pump device 2 that is assembled to the base body 10; a freely openable/closable hydraulic pressure regulating valve 3 (see FIG. 2) that is provided in each of the front-wheel hydraulic circuit C1 and the rear-wheel hydraulic circuit C2; drive coils (not illustrated) that respectively drive the hydraulic pressure regulating valves 3; a coil casing 12 that accommodates the drive coils; a motor 13 as a power source of the pump device 2; a controller casing 14 that accommodates a controller (not illustrated) for controlling operations of the pump device 2 and the hydraulic pressure regulating valves 3; and the like.

Next, a description will be made on a configuration of each section of the brake hydraulic pressure controller 1.

The base body 10 is made of metal such as aluminum and is formed of a substantially cuboid block. The base body 10 has a first surface 10A, a second surface 10B, a third surface 10C, a fourth surface 10D, a fifth surface 10E, and a sixth surface 10F.

The first surface 10A corresponds to the “first surface” in the invention. The sixth surface 10F corresponds to the “second surface” in the invention.

The first surface 10A is a surface that is located on an upper side of the sheet in FIG. 3 and FIG. 4. The second surface 10B is a surface that is located on a left side of the sheet in FIG. 3 and FIG. 4. The third surface 10C is a surface that is located on a right side of the sheet in FIG. 3 and FIG. 4. The fourth surface 10D is a surface that is located on a lower side of the sheet in FIG. 3 and FIG. 4. The fifth surface 10E is a surface, to which the coil casing 12 is attached, in FIG. 3 and FIG. 4. The sixth surface 10F is a surface, to which the motor 13 is attached, in FIG. 3 and FIG. 4.

That is, the first surface 10A opposes the fourth surface 10D, the second surface 10B opposes the third surface 10C, and the fifth surface 10E opposes the sixth surface 10F.

As illustrated in FIG. 2, the internal channel 4, through which the hydraulic fluid flows, is formed in the base body 10.

The internal channel 4 is configured by including: a first internal channel 4A, a second internal channel 4B, and a third internal channel 4C that constitute a part of the front-wheel hydraulic circuit C1; and a fourth internal channel 4D, a fifth internal channel 4E, and a sixth internal channel 4F that constitute a part of the rear-wheel hydraulic circuit C2.

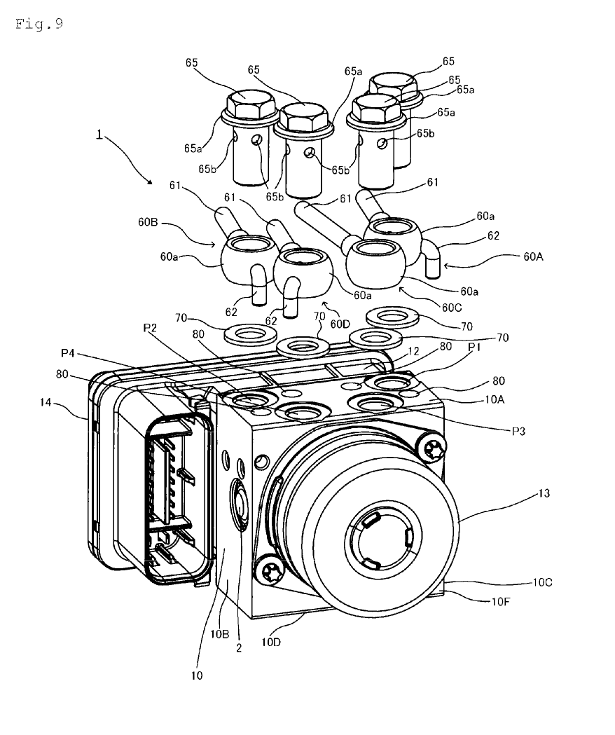

Various ports P are opened on the first surface 10A of the base body 10 (see FIG. 8). As illustrated in FIG. 3 to FIG. 7, banjos 60 (a banjo 60A to a banjo 60D) are respectively mounted on the various ports P.

As illustrated in FIG. 2, the various ports P include: a port P1 that corresponds to drive mechanisms such as the handlebar lever 24; a port P2 that corresponds to the drive mechanisms such as the foot pedal 34; a port P3 that corresponds to the drive mechanisms such as the front brake pad 21; and a port P4 that corresponds to the drive mechanisms such as the rear brake pad 31.

The banjo 60A is mounted on the port P1, and the brake fluid pipe 27 communicates with the first internal channel 4A via the banjo 60A.

The banjo 60B is mounted on the port P2, and the brake fluid pipe 37 communicates with the fourth internal channel 4D via the banjo 60B.

The banjo 60C is mounted on the port P3, and the brake fluid pipe 23 communicates with the second internal channel 4B via the banjo 60C.

The banjo 60D is mounted on the port P4, and the brake fluid pipe 33 communicates with the fifth internal channel 4E via the banjo 60D.

Note that the banjo 60A, the banjo 60B, and the banjo 60D correspond to the “first banjo” in the invention. The port P1, on which the banjo 60A is mounted, the port P2, on which the banjo 60B is mounted, and the port P4, on which the banjo 60D is mounted, correspond to the “first port” in the invention.

The banjo 60C corresponds to the “second banjo” in the invention. The port P3, on which the banjo 60C is mounted, corresponds to the “second port” in the invention.

In the following description, the banjo 60A, the banjo 60B, and the banjo 60D may collectively be referred to as first banjos 60. The banjo 60C may be referred to as a second banjo 60.

If there is no need to particularly distinguish the banjo 60A, the banjo 60B, the banjo 60C, and the banjo 60D for the description, they will collectively be referred to as the banjos 60 for the description.

Of the internal channel 4, the first internal channel 4A is connected to a hydraulic fluid outflow side of the pump device 2, a first pressure booster valve 3A as one of the hydraulic pressure regulating valves 3, and the port P1. In addition, the first internal channel 4A is provided with a first float restrictor 5A that restricts a flow rate of the hydraulic fluid flowing through the internal channel 4.

Of the internal channel 4, the second internal channel 4B is connected to the first pressure booster valve 3A, a first pressure reduction valve 3B as one of the hydraulic pressure regulating valves 3, and the port P3.

Of the internal channel 4, the third internal channel 4C is connected to a hydraulic fluid inflow side of the pump device 2 and the first pressure reduction valve 3B. In addition, the third internal channel 4C is provided with an accumulator 6 that stores the hydraulic fluid in the internal channel 4.

Of the internal channel 4, the fourth internal channel 4D is connected to the hydraulic fluid outflow side of the pump device 2, a second pressure booster valve 3C as one of the hydraulic pressure regulating valves 3, and the port P2. In addition, the fourth internal channel 4D is provided with a second float restrictor 5B that restricts the flow rate of the hydraulic fluid flowing through the internal channel 4.

Of the internal channel 4, the fifth internal channel 4E is connected to the second pressure booster valve 3C, a second pressure reduction valve 3D as one of the hydraulic pressure regulating valves 3, and the port P4.

Of the internal channel 4, the sixth internal channel 4F is connected to the hydraulic fluid inflow side of the pump device 2 and the second pressure reduction valve 3D. In addition, the sixth internal channel 4F is provided with the accumulator 6 that stores the hydraulic fluid in the internal channel 4.

The pump device 2 is accommodated in a pump opening that is formed on the second surface 10B and the third surface 10C as the two opposing surfaces of the base body 10.

The motor 13 is attached to the sixth surface 10F of the base body 10.

The coil casing 12 is attached to the fifth surface 10E of the base body 10.

The pump device 2 includes two pump elements 2E, to each of which drive power is supplied by the motor 13 such as a DC motor. Each of the pump elements 2E is driven by the motor 13 to reciprocate. An operation of the motor 13 is controlled by the controller.

One of the pump elements 2E is used to feed the hydraulic fluid in the front-wheel hydraulic circuit C1 and feeds the hydraulic fluid in the third internal channel 4C to the first internal channel 4A side.

The other pump element 2E is used to feed the hydraulic fluid in the rear-wheel hydraulic circuit C2 and feeds the hydraulic fluid in the sixth internal channel 4F to the fourth internal channel 4D side.

Next, a description will be made on attachment of the banjos 60 to the base body 10 by using FIG. 8 to FIG. 10.

FIG. 8 is an exploded perspective view of the brake hydraulic pressure controller according to the first embodiment. FIG. 9 is an exploded perspective view of the brake hydraulic pressure controller according to the first embodiment that is seen at a different angle from FIG. 8. FIG. 10 is a view illustrating a position of a bottomed hole that is formed in the base body of the brake hydraulic pressure controller according to the first embodiment.

As described above, the banjos 60 are respectively attached to the various ports P that are opened on the first surface 10A of the base body 10.

Plural bottomed holes 80 are formed on the first surface 10A of the base body 10.

That is, the ports P and the bottomed holes 80 are formed on the same surface of the base body 10.

The bottomed holes 80 are each perforated in specified depth on an outer surface (the first surface 10A) of the base body 10 and are each configured to prevent an inflow of the hydraulic fluid into an entire region of the specified depth. That is, the bottomed holes 80 are formed irrespective of formation of the internal channel 4.

Note that a shape of the bottomed hole 80 is not particularly limited and may be a circle as illustrated or may be an ellipse, an elongated circle, or the like.

As illustrated in FIG. 8 and FIG. 9, the first banjo 60 includes: a body 60a; a first end 61 that extends outward from the body 60a, and to which a brake pipe is connected; and a second end 62 that extends outward from the body 60a, and to which the brake pipe is not connected.

As illustrated in FIG. 8 and FIG. 9, the second banjo 60 includes: a body 60a; and a first end 61 that extends outward from the body 60a, and to which the brake pipe is connected.

The body 60a is constructed of a cylindrical metal fitting.

The first end 61 and the second end 62 are connected to an outer peripheral surface of the body 60a of the first banjo 60 in a manner to be projected outward.

The first end 61 is connected to an outer peripheral surface of the body 60a of the second banjo 60 in a manner to be projected outward.

The bodies 60a are respectively attached to the various ports P on the first surface 10A of the base body 10 via seal members 70.

The first end 61 extends from the body 60a to the outside of the base body 10, and the brake pipe is connected to a tip thereof.

The second end 62 extends from the body 60a and is inserted in the bottomed hole 80. Alternatively, the second end 62 extends from the body 60a to the outside of the base body 10 and is locked to an edge on a side of the base body 10. More specifically, the second end 62 is bent to the base body 10 side at a specified angle. In this way, the second end 62 can be inserted in the bottomed hole 80, or the second end 62 can be locked to the edge on the side of the base body 10.

However, as will be described in a second embodiment, rotation of the banjo 60 may be prevented by bringing the banjo 60 into contact with the adjacent banjo 60.

A banjo bolt 65 is screwed to the port P in a state of being inserted in a through-hole of the body 60a. In this way, the banjo 60 is fixed to the first surface 10A of the base body 10.

The banjo bolt 65 has a flange section 65a on one end side (an opposite side of an inserted side).

A fluid channel is formed in the banjo bolt 65. This fluid channel extends axially at a center of the banjo bolt 65. A tip on the other end side of the banjo bolt 65 is opened.

In addition, an opening 65b that serves as a part of the fluid channel is formed at two positions on an outer peripheral surface of the banjo bolt 65.

The opening 65b is located on an inner side of the body 60a of the banjo 60 when the banjo bolt 65 is attached to the base body 10.

When the brake hydraulic pressure controller 1 is assembled, the brake pipe and the internal channel 4 of the base body 10 are brought into a communicating state via the banjo 60.

That is, the hydraulic fluid that flows between the brake pipe and each of the various ports P flows through the first end 61, the opening 65b formed in the banjo bolt 65, and the fluid channel formed in the banjo bolt 65.

The rotation of the first banjo 60 is prevented by inserting the second end 62 in the bottomed hole 80 or locking the second end 62 to the edge on the side of the base body 10.

More specifically, the second end 62 of the banjo 60A is locked to an edge of the third surface 10C of the base body 10.

The second end 62 of the banjo 60B is inserted in the bottomed hole 80.

The second end 62 of the banjo 60D is locked to an edge of the sixth surface 10F of the base body 10.

The second banjo 60 is not provided with the second end 62.

More specifically, the rotation of the banjo 60C is prevented by bringing the first end 61 into contact with the banjo 60A. That is, the rotation of the banjo 60C is indirectly prevented by being locked to the adjacent banjo 60A.

Here, the side of the base body 10 means any of surfaces (the second surface 10B, the third surface 10C, the fifth surface 10E, and the sixth surface 10F) continuing from a surface (the first surface 10A) to which the banjo 60 is attached.

### <Position Where Bottomed Hole 80 is Formed>

A description will be made on positions where the bottomed hole 80 is formed by using FIGS. 10 to 12.

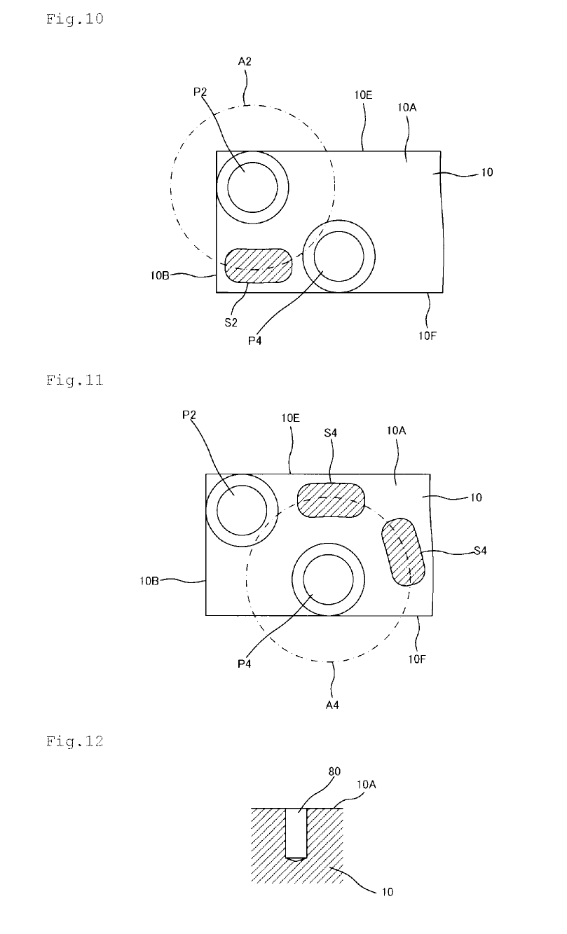

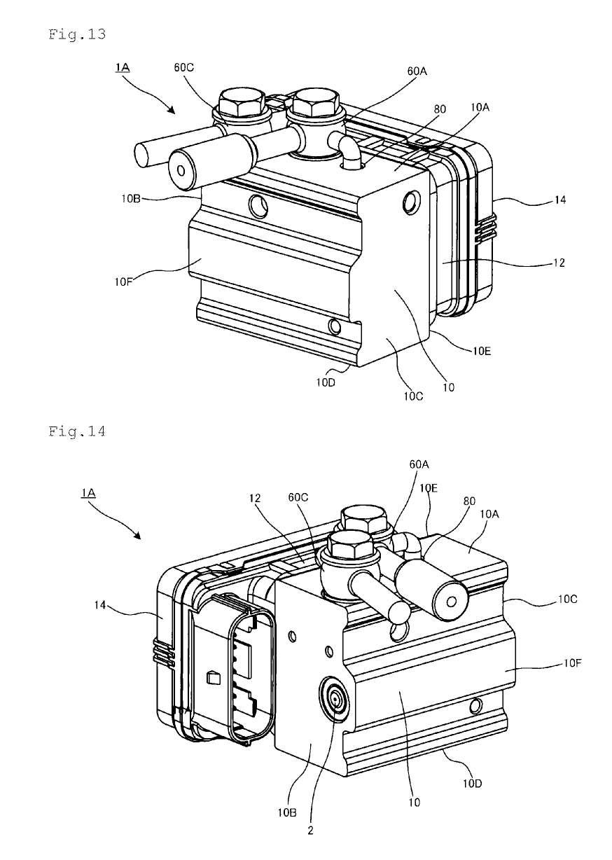

FIG. 10 to FIG. 12 are views illustrating the positions of the bottomed hole that is formed in the base body of the brake hydraulic pressure controller according to the first embodiment. Note that FIG. 10 illustrates the position where the bottomed hole 80 is formed for the port P2. FIG. 11 illustrates the position where the bottomed hole 80 is formed for the port P4. FIG. 12 schematically illustrates a cross section of the base body 10 at the position where the bottomed hole 80 is formed. Here, a description will be made on the positions where the bottomed holes 80 that correspond to the port P2 and the port P4 are formed; however, the same applies to the positions where the bottomed holes 80 that correspond to the port P1 and the port P3 are formed.

As described above, the second end 62 of the first banjo 60 is inserted in the bottomed hole 80. In addition, as illustrated in FIG. 12, the bottomed hole 80 is formed by being perforated in the specified depth on the outer surface of the base body 10. The hydraulic fluid does not flow into the entire region of the bottomed hole 80.

As illustrated in FIG. 10, the bottomed hole 80 for the port P2 is formed in a space S2 that is located on a circumference of a concentric circle A2 with the port P2. The concentric circle A2 with the port P2 corresponds to a trajectory of the second end 62 of the banjo 60B at a time when the second end 62 rotates.

As illustrated in FIG. 11, the bottomed hole 80 for the port P4 is formed in a space S4 that is located on a circumference of a concentric circle A4 with the port P4. The concentric circle A4 with the port P4 corresponds to a trajectory of the second end 62 of the banjo 60D at a time when the second end 62 rotates.

### <Effects>

In the brake hydraulic pressure controller 1 according to the first embodiment, the second end 62 of the first banjo 60, to which the brake pipe is not connected, is inserted in the bottomed hole 80 that is perforated in the specified depth on the outer surface (the first surface 10A) of the base body 10, and into which the hydraulic fluid does not flow in the entire region of the specified depth. In this way, the rotation of the banjo 60 is prevented. Alternatively, the second end 62 of the first banjo 60, to which the brake pipe is not connected, extends to the outside of the side (the second surface 10B or the like) of the base body 10 and is locked to the edge of the side (the second surface 10B or the like) of the base body 10. In this way, the rotation of the banjo is prevented.

Accordingly, the structure of the internal channel 4, a hydraulic fluid sealing property, and the like become less restrictive. Thus, applicability of a detent mechanism that prevents corotation of the banjo 60 is improved. That is, differing from a configuration that the bottomed hole in the specified depth is perforated on the outer surface of the base body 10 to form the internal channel 4 in the base body 10 and that the hydraulic fluid only flows into a deep side of an intermediate section of the bottomed hole by closing the intermediate section, the position where the bottomed hole 80 is formed can be determined under the further alleviated restriction on the configuration of the internal channel 4. In addition, the banjo bolts 65 can be screwed under a reduced influence of the hydraulic fluid sealing property.

In the brake hydraulic pressure controller 1 according to the first embodiment, the bottomed holes 80 are formed on the same surface (the first surface 10A) as the ports P of the base body 10. Thus, the base body 10 can effectively be used, and downsizing of the brake hydraulic pressure controller 1 can be realized.

In the brake hydraulic pressure controller 1 according to the first embodiment, the second banjo 60 is locked to the first banjo 60. Thus, the structure of the brake hydraulic pressure controller 1 can be simplified. In particular, because the first end 61 of the second banjo 60 is locked to the first banjo 60, necessity of forming the second end 62 in all of the banjos 60 is reduced. Thus, the number of components can be reduced, and downsizing of the brake hydraulic pressure controller 1 can be realized.

In the brake hydraulic pressure controller 1 according to the first embodiment, a motor opening, in which one end of the motor 13 is accommodated, is formed on the surface (the sixth surface 10F) of the base body 10 that is not formed with the port P. Thus, the base body 10 can further effectively be used.

The brake hydraulic pressure controller 1 according to the first embodiment is mounted on the motorcycle 200. A demand for downsizing of built-in equipment in the motorcycle 200 has been particularly stringent. Thus, the brake hydraulic pressure controller 1 according to the embodiment is particularly useful for the motorcycle 200.

### Second Embodiment

### <Configuration of Brake Hydraulic Pressure Controller 1A>

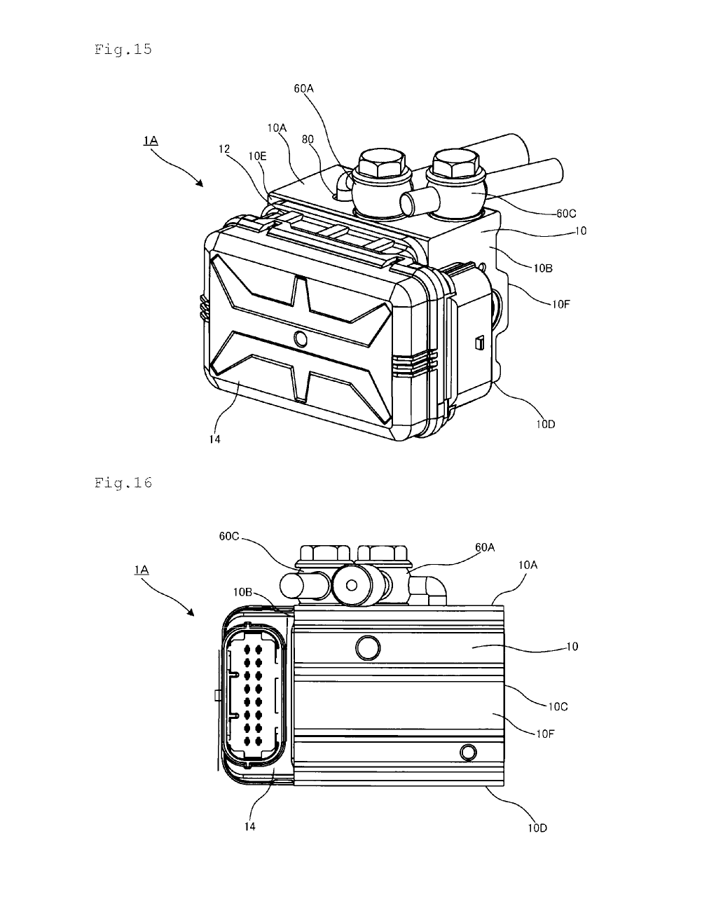

A description will be made on a brake hydraulic pressure controller according to the second embodiment by using FIG. 13 to FIG. 22. Note that the description of the second embodiment will be centered on different points from the first embodiment, the same portions as those in the first embodiment will be denoted by the same reference signs, and the description thereon will not be made.

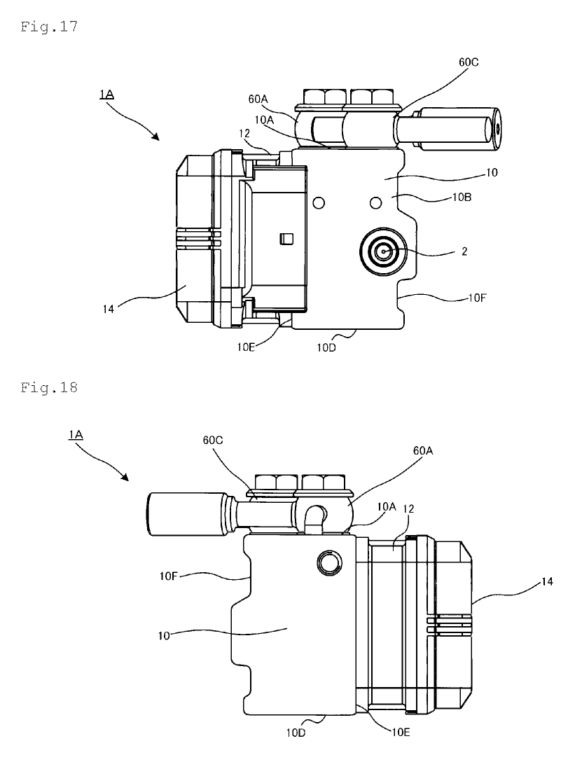

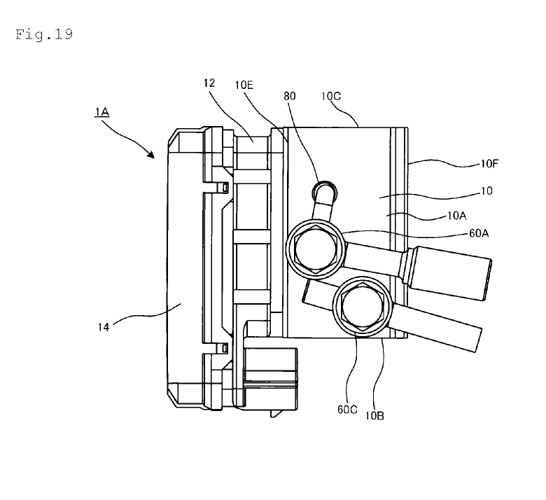

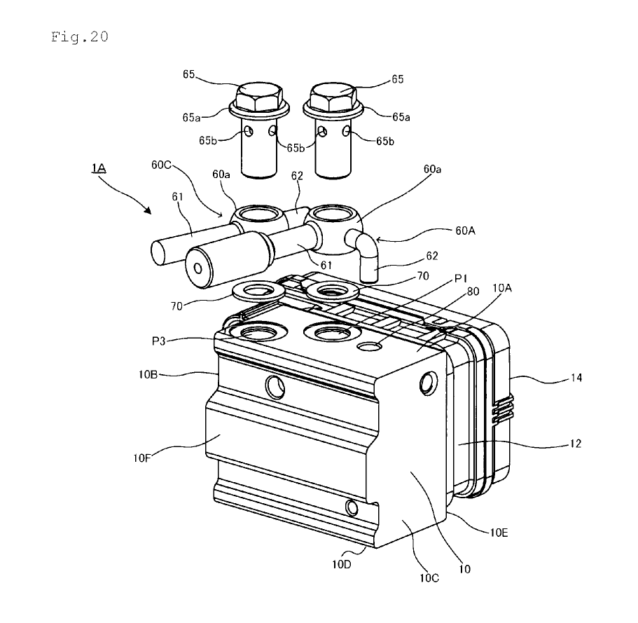

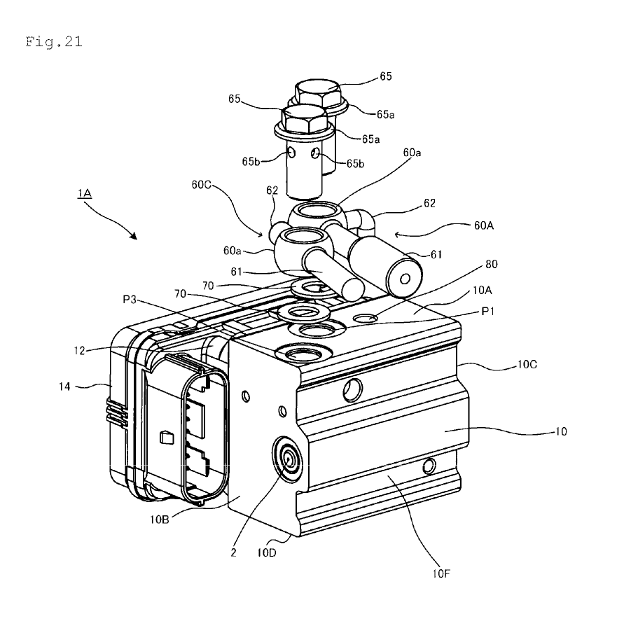

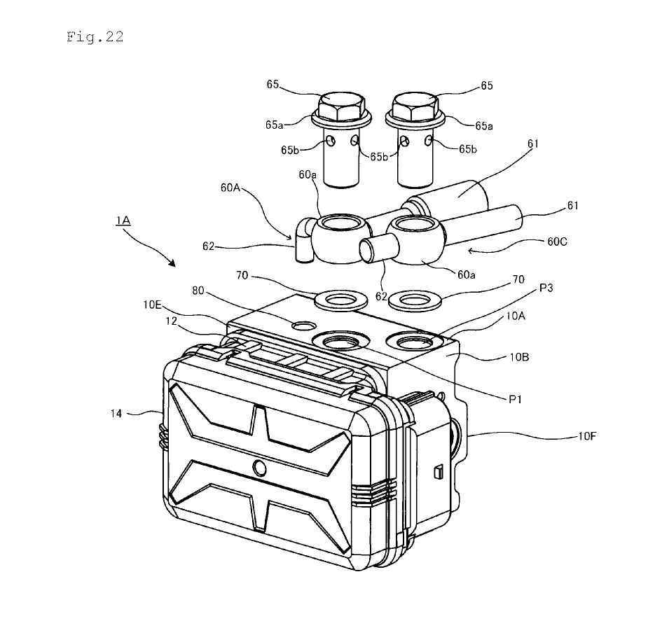

FIG. 13 is a perspective view of the brake hydraulic pressure controller according to the second embodiment. FIG. 14 is a perspective view of the brake hydraulic pressure controller according to the second embodiment that is seen at a different angle from FIG. 13. FIG. 15 is a perspective view of the brake hydraulic pressure controller according to the second embodiment that is seen at a different angle from FIG. 13. FIG. 16 is a front view of the brake hydraulic pressure controller according to the second embodiment. FIG. 17 is a side view of the brake hydraulic pressure controller according to the second embodiment. FIG. 18 is a side view of the brake hydraulic pressure controller according to the second embodiment that is seen from a different side from FIG. 17. FIG. 19 is a top view of the brake hydraulic pressure controller according to the second embodiment. FIG. 20 is an exploded perspective view of the brake hydraulic pressure controller according to the second embodiment. FIG. 21 is an exploded perspective view of the brake hydraulic pressure controller according to the second embodiment that is seen at a different angle from FIG. 20. FIG. 22 is an exploded perspective view of the brake hydraulic pressure controller according to the second embodiment that is seen at a different angle from FIG. 20.

In the first embodiment, the description has been made on the brake hydraulic pressure controller 1 that includes both of the front-wheel hydraulic circuit C1 and the rear-wheel hydraulic circuit C2 as the example. In the second embodiment, a description will be made on a brake hydraulic pressure controller 1A that includes only one of the front-wheel hydraulic circuit C1 and the rear-wheel hydraulic circuit C2. That is, only the two ports P are formed in the base body 10 of the brake hydraulic pressure controller 1A. Note that a description will be made on a case where the front-wheel hydraulic circuit C1 is provided for a matter of convenience.

As described in the first embodiment, the various ports P are formed on the first surface 10A of the base body 10. More specifically, the various ports P include: the port P1 that corresponds to the drive mechanisms such as the handlebar lever 24; and the port P3 that corresponds to the drive mechanisms such as the front brake pad 21.

The banjo 60A is mounted on the port P1, and the brake fluid pipe 27 communicates with the first internal channel 4A via the banjo 60A.

The banjo 60C is mounted on the port P3, and the brake fluid pipe 23 communicates with the second internal channel 4B via the banjo 60C.

Note that the banjo 60A corresponds to the “first banjo” in the invention. The port P1, on which the banjo 60A is mounted, corresponds to the “first port” in the invention.

The banjo 60C corresponds to the “second banjo” in the invention. The port P3, on which the banjo 60C is mounted, corresponds to the “second port” in the invention.

The banjo 60A may be referred to as the first banjo 60 in the following description. The banjo 60C may be referred to as the second banjo 60.

If there is no need to particularly distinguish the banjo 60A and the banjo 60C from each other, they will collectively be referred to as the banjos 60 for the description.

The pump device 2 is accommodated in the pump opening that is formed on the second surface 10B of the base body 10.

The coil casing 12 is attached to the fifth surface 10E of the base body 10.

Note that the motor is covered by the coil casing 12 in a state where the end thereof is accommodated in the motor opening formed on the fifth surface 10E of the base body 10. The fifth surface 10E corresponds to the “second surface” in the invention.

As illustrated in FIG. 20 to FIG. 22, the port P1 and the port P3 are opened on the first surface 10A of the base body 10.

One bottomed hole 80 is formed on the first surface 10A of the base body 10. The position where the bottomed hole 80 is formed is as described in the first embodiment.

That is, the ports P and the bottomed hole 80 are formed on the same surface of the base body 10.

As described in the first embodiment, the first banjo 60 includes the body 60a, the first end 61, the second end 62, and the banjo bolt 65.

As illustrated in FIG. 20 to FIG. 22, the second banjo 60 also includes the body 60a, the first end 61, the second end 62, and the banjo bolt 65.

The second end 62 of the second banjo 60 linearly extends outward from the body 60a. Then, the rotation of the second banjo 60 is prevented by bringing the second end 62 of the second banjo 60 into contact with the first banjo 60.

### <Effects>

In the brake hydraulic pressure controller 1A according to the second embodiment, the second banjo 60 is locked to the first banjo 60. Thus, a structure of the brake hydraulic pressure controller 1A can be simplified. In particular, the second end 62 of the second banjo 60 is locked to the first banjo 60. Thus, freedom in the shape of the second end 62 is improved, and cost cut for the components and the like can be achieved.

In the brake hydraulic pressure controller 1A according to the second embodiment, the plural regulating valve openings, in which the plural hydraulic pressure regulating valves 3 are respectively accommodated, are formed on the same surface (the fifth surface 10E) as the motor opening, in which the one end of the motor 13 is accommodated. Thus, the base body 10 can further effectively be used.

What is claimed is:

1. A brake hydraulic pressure controller comprising:
a base body that is formed with a channel for a hydraulic fluid therein, wherein
a first banjo with a first end, to which a brake pipe is connected, is fixed to a first port of the channel by a banjo bolt, and
a second end of the first banjo, to which the brake pipe is not connected, is inserted in a bottomed hole that is perforated in specified depth on an outer surface of the base body and into which the hydraulic fluid does not flow in an entire region of the specified depth, or extends to the outside of a side of the base body and is locked to an edge on the side of the base body.

2. The brake hydraulic pressure controller according to claim 1, wherein
the second end of the first banjo is inserted in the bottomed hole, and
the bottomed hole is formed on a first surface of the base body that is formed with the first port.

3. The brake hydraulic pressure controller according to claim 1, wherein
a second banjo with a first end, to which the brake pipe is connected, is fixed to a second port of the channel by a banjo bolt, and
the second banjo is locked to the first banjo.

4. The brake hydraulic pressure controller according to claim 3, wherein
the first end of the second banjo is locked to the first banjo.

5. The brake hydraulic pressure controller according to claim 3, wherein
a second end of the second banjo, to which the brake pipe is not connected, is locked to the first banjo.

6. The brake hydraulic pressure controller according to claim 3, wherein
the second port is formed on the first surface of the base body that is formed with the first port.

7. The brake hydraulic pressure controller according to claim 1 further comprising:
a pump device that is accommodated in a pump opening formed on the base body and applies pressure to the hydraulic fluid; and
a motor, one end of which is accommodated in a motor opening formed on the base body, and that serves as a drive source of the pump device, wherein
the motor opening is formed on a second surface of the base body that differs from the first surface formed with the first port.

8. The brake hydraulic pressure controller according to claim 7 further comprising:
plural hydraulic pressure regulating valves that are respectively accommodated in plural regulating valve openings formed on the base body to open/close the channel; and
plural drive coils that are respectively provided in the plural hydraulic pressure regulating valves to drive the hydraulic pressure regulating valves, wherein
the plural regulating valve openings are formed on the second surface of the base body.

9. The brake hydraulic pressure controller according to claim 2, wherein
a second banjo with a first end, to which the brake pipe is connected, is fixed to a second port of the channel by a banjo bolt, and
the second banjo is locked to the first banjo.

10. The brake hydraulic pressure controller according to claim 9, wherein
the first end of the second banjo is locked to the first banjo.

11. The brake hydraulic pressure controller according to claim 10, wherein
the second port is formed on the first surface of the base body that is formed with the first port.

12. The brake hydraulic pressure controller according to claim 11 further comprising:
a pump device that is accommodated in a pump opening formed on the base body and applies pressure to the hydraulic fluid; and
a motor, one end of which is accommodated in a motor opening formed on the base body, and that serves as a drive source of the pump device, wherein
the motor opening is formed on a second surface of the base body that differs from the first surface formed with the first port.

13. The brake hydraulic pressure controller according to claim 12 further comprising:
plural hydraulic pressure regulating valves that are respectively accommodated in plural regulating valve openings formed on the base body to open/close the channel; and
plural drive coils that are respectively provided in the plural hydraulic pressure regulating valves to drive the hydraulic pressure regulating valves, wherein
the plural regulating valve openings are formed on the second surface of the base body.

14. The brake hydraulic pressure controller according to claim 9, wherein
a second end of the second banjo, to which the brake pipe is not connected, is locked to the first banjo.

15. The brake hydraulic pressure controller according to claim 14, wherein
the second port is formed on the first surface of the base body that is formed with the first port.

16. The brake hydraulic pressure controller according to claim 15 further comprising:
a pump device that is accommodated in a pump opening formed on the base body and applies pressure to the hydraulic fluid; and
a motor, one end of which is accommodated in a motor opening formed on the base body, and that serves as a drive source of the pump device, wherein
the motor opening is formed on a second surface of the base body that differs from the first surface formed with the first port.

17. The brake hydraulic pressure controller according to claim 16 further comprising:
plural hydraulic pressure regulating valves that are respectively accommodated in plural regulating valve openings formed on the base body to open/close the channel; and
plural drive coils that are respectively provided in the plural hydraulic pressure regulating valves to drive the hydraulic pressure regulating valves, wherein
the plural regulating valve openings are formed on the second surface of the base body.

18. A motorcycle comprising:
the brake fluid pressure controller according to claim 1.
